(19) United States
(12) Patent Application Publication
(10) Pub. No.: US 2018/0262445 A1
(43) Pub. Date: Sep. 13, 2018

(54) CROSS-REGION MULTILEVEL BAND STRUCTURE AND SYSTEM AND METHOD APPLYING THE SAME FOR BROADCASTING

(71) Applicant: Smart Mobile Broadcasting Technology, Inc., Taipei (TW)

(72) Inventors: Chia-Shiang Shih, Taipei (TW); Tao-Hsuan Wu, Taipei (TW); Cheng-Min Jen, Taipei (TW); Hou-Chen Liao, Taipei (TW); Han-Lin Shih, Taipei (TW)

(21) Appl. No.: 15/782,143

(22) Filed: Oct. 12, 2017

(30) Foreign Application Priority Data
Mar. 8, 2017 (TW) 106107525
Mar. 8, 2017 (TW) 106203228

(51) Int. Cl. H04L 12/927; H04L 12/801; H04W 84/04; H04W 28/02

(52) U.S. Cl. CPC H04L 47/806; H04W 28/02; H04W 84/042; H04L 47/12

(57) ABSTRACT

A method of a cross-region multilevel band broadcast structure includes: selecting a main band for broadcasting in a full region; selecting a first secondary band for broadcasting in a first region within the full region; and selecting a second secondary band for broadcasting in a second region within the full region. The main band, the first secondary band and the second secondary band are different bands.

### RELATED APPLICATIONS

This application claims priority to Taiwan Application Serial Number 106107525, filed on Mar. 8, 2017 and Taiwan Application Serial Number 106203228, filed on Mar. 8, 2017, which is incorporated by reference herein in its entirety.

### BACKGROUND OF THE INVENTION

### Field of the Invention

The present invention relates to a method of a multilevel band structure, and more particularly, to a system and method applying the multilevel band structure for broadcasting.

### Description of the Prior Art

With the popularity of wireless communication devices such as cell phones in the recent years, high-speed wireless communication networks also continue progressing. People have gradually become in habit of retrieving various multimedia messages such as audios, images and videos from the Internet at all times and at all places.

However, because wireless communication devices such as cell phones are point-to-point transmission, the same data is repeatedly transmitted to different users when the same data is concurrently retrieved by multiple individuals, hence causing unnecessary waste in bandwidth. Particularly, in a small-area and concurrent multi-user application, e.g., a singing concert, network congestions are frequently resulted, which hinders those in need of urgently contacting others from accessing spectrum resources. In the vision of establishing future smart cities, as the number of devices applied continues increasing, it can be anticipated that the current communication means of wireless devices such as cell phones may not satisfy colossal amounts of data transmission and update requirements. Therefore, there is an urgent need for a novel wireless communication broadcasting method to solve the above issue.

A conventional broadcasting method is capable of performing one-to-many information transmission. However, if broadcast is conducted by full-range broadcast, regional characteristics cannot be broadcasted in specific regions to satisfy regional users. Further, the frequency band cannot be used for other purposes, such that waste from another perspective is caused. However, if broadcast is conducted by regional broadcast, idle bands (white spaces) that cannot be effectively utilized are incurred in the regions.

### SUMMARY OF THE INVENTION

In view of the above issues of conventional broadcast methods, it is an object of the present invention to provide a method of a cross-region multilevel band broadcast structure. The method includes: selecting a main band for broadcasting in a full region; selecting a first secondary band for broadcasting in a first region within the full region; and selecting a second secondary band for broadcasting in a second region within the full region. The main band, the first secondary band and the second secondary band are different bands.

Preferably, in the method of a cross-region multilevel band broadcast structure, the first region is in a plural quantity, and the plurality of first regions are not adjacent to one another in the full region. The second region is in a plural quantity, and the plurality of second regions are not adjacent to one another in the full region. The first region and the second region are both in plural quantities, and are alternately arranged in the full region. The method further includes: selecting a third secondary band for broadcasting in a third region within the full region. The first region, the second region and the third region are all in plural quantities, and are staggered in an alternating arrangement in the full region such that the plurality of first regions are not adjacent to one another, the plurality of second regions are not adjacent to one another and the plurality of third regions are not adjacent to one another.

The present invention further provides a method for broadcasting under a cross-region multilevel band broadcast structure. The method includes: the foregoing method of a cross-region multilevel band broadcast structure; and selecting the second band for field broadcast in a field within the first region, wherein the field is not adjacent to the second region.

With the present invention, because information is transmitted by broadcasting, information may be simultaneously transmitted to multiple users, so as to effectively solve the waste in bandwidth caused by repeatedly transmitting the same information to multiple users in point-to-point network broadcasting and to further prevent network congestions. Further, because different bands are respectively utilized in the full region, the first region and the second region, the idle bands in the regions may be effectively used for information transmission in small fields without interfering current spectra, thereby preventing spectrum interference and achieving effective information broadcasting.

### BRIEF DESCRIPTION OF THE DRAWINGS

FIG. 1 is a schematic diagram of a cross-region multilevel band structure according to a first embodiment of the present invention;

FIG. 2 is a schematic diagram of a cross-region multilevel band structure according to a second embodiment of the present invention;

FIG. 3 is a schematic diagram of a cross-region multilevel band structure according to a third embodiment of the present invention;

FIG. 4 is a schematic diagram of a cross-region multilevel band structure according to a fourth embodiment of the present invention;

FIG. 5 is a schematic diagram of a cross-region multilevel band structure applied to a broadcast system for broadcasting guide information in an exhibition venue according to a fifth embodiment of the present invention;

FIG. 6 is a schematic diagram of a cross-region multilevel band structure applied to a broadcast system for broadcasting live scenes at a gathering and marching venue according to a sixth embodiment of the present invention;

FIG. 7 is a schematic diagram of a cross-region multilevel band structure applied to a broadcast system for broadcasting urgent messages associated with medical emergencies according to a seventh embodiment of the present invention;

FIG. 8 is a schematic diagram of a cross-region multilevel band structure applied to a broadcast system for broadcasting integrated traffic information of a smart city according to an eighth embodiment of the present invention;

FIG. 9 is a schematic diagram of a cross-region multilevel band structure applied to a broadcast system for broadcasting search and rescue information in an event of a major disaster according to a ninth embodiment of the present invention;

FIG. 10 is a schematic diagram of a cross-region multilevel band structure applied to a broadcast system for broadcasting information of a smart newspaper distribution center according to a tenth embodiment of the present invention; and

FIG. 11 is a schematic diagram of a cross-region multilevel band structure applied to a broadcast system for broadcasting cross-region information of an auxiliary backbone network according to an eleventh embodiment of the present invention.

### DETAILED DESCRIPTION OF THE EMBODIMENTS

The present invention provides a method of a cross-region multilevel band broadcast structure. The method includes: selecting a main band for broadcasting in a full region; selecting a first secondary band for broadcasting a first region within the full region; and selecting a second secondary band for broadcasting in a second region within the full region, wherein the main band, the first secondary band and the second secondary band are different bands. The above method is capable of effectively solving the issue of bandwidth waste caused by repeatedly transmitting the same information to multiple users in point-to-point network broadcast to further prevent network congestions. By using the bands in a cross-region and band division manner, regional broadcast information can be transmitted within respective regions. Further, in a field outside these regions, idle bands (white spaces) can be utilized without interfering existing bands, hence effectively transmitting information in the field to achieve efficient information broadcast.

In the present invention, the term “multilevel” refers to a region division and band division broadcast method in a full region, so as to maximize utilization efficiency in limited bands.

In the present invention, the term “broadcast” refers to the transmission of information using electromagnetic waves as carriers. More specifically, information is transmitted by a transmitter to a plurality of receivers in a “one-directional one-to-many” approach. Alternatively, depending on environmental requirements, information exchange may be conducted between a plurality of transmitters and a plurality of receivers in a “bi-directional one-to-many” approach. More specifically, standards such as the European Digital Video Broadcasting (DVB) series standards, the Japanese Integrated Services Digital Broadcasting (ISDB) series standards, the U.S. Advanced Television Systems Committee (ATSC) standard, the Chinese Digital Terrestrial Multimedia Broadcast (DTMB) standard, the Korean Terrestrial—Digital Multimedia Broadcasting (T-DMB) standard, and the European Digital Audio Broadcasting (DAB) series standards may be adopted. The term “series” refers to multiple current and future standard specifications on digital television broadcasting technologies of the same standard organization, e.g., DVB-T, DVB-T2, ISDB-T, ISDB-Tmm, ISDB-Tsb, ATSC 1.0, ATSC 2.0, ATSC 3.0, DAB and DAB+.

In the present invention, the term “main band” refers to a radio broadcast band, preferably within the range of the Ultra High Frequency (UHF), Very High Frequency (VHF) or U.S. CBRS band (licensed bands newly open to application by FCC in the year 2015, located between 3550 MHz and 3700 MHz, with each channel bandwidth being 10 MHz). Preferably, the main band is a 1 MHz to 10 MHz band of a digital wireless television band. Being applied to broadcast within a full region, the “main band” is suitable for transmitting information in the full region to effectively achieve the benefit of real-time information broadcast in the full region.

The term “full region” refers to a broadcast region within which a transmitter transmits information by the “main band”, and may be a “full region” that is constructed by signals transmitted from one single transmitter and is usually a circular region. Alternatively, through the control of signal ends by a plurality of transmitters, information transmitted from different base stations by using the “main band” do not interfere information transmitted from another, so as to construct a continuous “full region”. At this point, such “full region” may have a shape adjustable by the configuration of the transmitters, and may be a circular region, a loop region, or a geometric region formed by overlapping circular regions.

In the present invention, the terms “first secondary band” and “second secondary band” refer to radio communication bands, e.g., broadcasting bands or digital television bands, preferably within the range of the UHF, VHF or U.S. CBRS band (licensed bands newly open to application by FCC in the year 2015, located between 3550 MHz and 3700 MHz, with each channel bandwidth being 10 MHz). Further, bands of the “first secondary band”, “second secondary band” and “main band” are non-overlapping. Preferably, the “first secondary band” and “second secondary band” may be continuous bands in a digital wireless television band to reduce device differences as well as costs. Preferably, corresponding band planning for the “first secondary band”, “second secondary band” and “main band” may be performed according to requirements, for example, bands are planned to be utilized with bandwidth from 1 MHz to 10 MHz, or according to every 6 MHz or 14.5 MHz. Because the “first secondary band” and “second secondary band” serve for broadcasting; purposes within the “first region” and “second region” within the “full region”, and the bands of the “first secondary band”, “second secondary band” and “main band” are non-overlapping, regional information may be transmitted within the “first region” and “second region” respectively.

Further, in the “full region”, each of the “first region” and “second region” may be in a plural quantity, and the “first regions” nor “second regions” in the “full region” are adjacent to one another. That is to say, in the “full region”, the “first regions” are not adjacent to one another, such that different regional information may be transmitted in the respective “first regions” without interference. Similarly, in the “full region”, the second regions” are not adjacent to one another, such that different regional information may be transmitted in the respective “second regions” without interference. Thus, in an effective band range, regional information may be transmitted for different regions. Preferably, the “first region” and “second region” are alternately arranged in the “full region”.

In the present invention, the term “third secondary band” has the same configuration as the “first secondary band” or “second secondary band” to conveniently plan the “third region”, so as to construct discontinuous “first regions”, “second regions” and “third regions” in the “full region”, thereby satisfying more different requirements of regional information broadcast and assisting the broadcast of cross-regional information constructed by an backbone network.

The present invention further provides a method for utilizing an idle band (white space) under the foregoing method of a cross-region multilevel band broadcast structure. The method includes: utilizing the aforementioned method of a cross-region multilevel band broadcast structure; and selecting the second secondary band for field broadcast in a field within the first region, wherein the field is not adjacent to the second region. The term “idle band” refers to a band range that is not used in the “field”. For example, when the “field” is located in the “first region” and outside the “second region”, the “second band” in the “field” is an idle band. At this point, the “second secondary band” may be used for broadcasting in the “first region” without interfering the existing “main band” and “first secondary band”.

The present invention further provides a broadcast system applied to a small field. The broadcast system includes: a broadcast transmission device, transmitting information from a signal source in form of broadcasting in the small field by using a band that is not used in the small field; and a broadcast reception device, receiving the information transmitted through the band. The broadcast system is capable of effectively solving the issue of bandwidth waste caused by repeatedly transmitting the same information to multiple users in point-to-point network broadcast to further prevent network congestions. By using idle spectra in small field broadcasting or digital television, information transmission can be effectively conducted in a small field without interfering existing spectra, thereby preventing spectrum interference to achieve efficient information broadcast.

In the present invention, the term “small field” refers to a possible range in which broadcast transmission signals can be received. More specifically, the “small field” may be the foregoing “first region”, “second region” or “third region”, a range of a singing concert, an exhibition venue, a plaza or a sports field, or a range within a radius of several kilometers regarding the broadcast transmission device as a center.

In the present invention, the term “broadcast transmission” refers to a transmission technology that allows multiple users in the small field to simultaneously receive the signal through the foregoing broadcasting method.

In the present invention, the term “signal source” refers to a device capable of providing information to be transmitted. More specifically, the “signal source” may be an image capturing device, e.g., a video camera, which captures images as information to be transmitted, or an information integration device, e.g., a director device, which integrates data from various locations into information to be transmitted. The data from various locations may be audiovisual frames captured by an audiovisual capturing device, or data inputted by an editor.

In the present invention, the term “broadcast reception” refers to a process of decoding corresponding signals transmitted by the foregoing “broadcast transmission” through the band to obtain the above information. More specifically, information transmitted through the band may be received by a broadcast reception device.

### First Embodiment

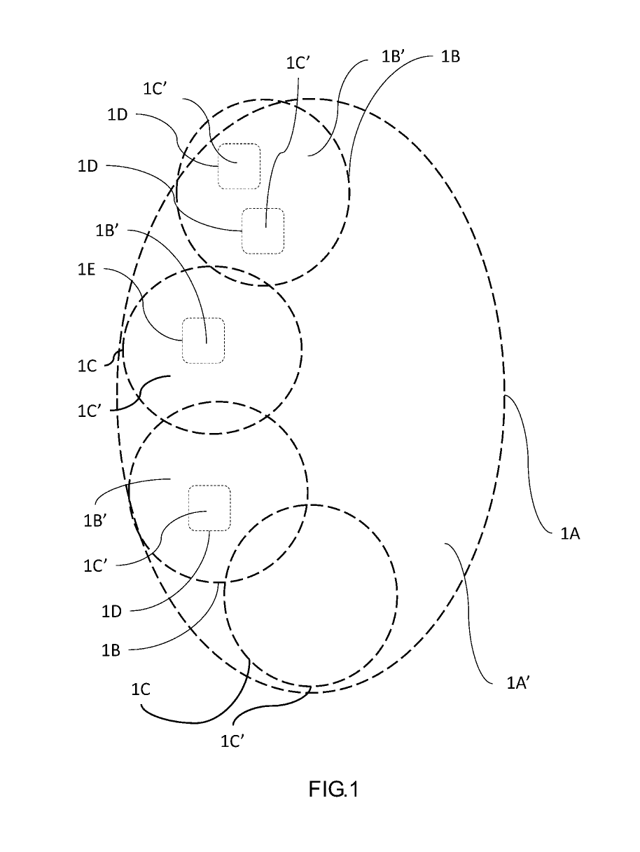

This embodiment is a cross-region multilevel band structure, as shown in FIG. 1. A full region 1A is first defined in a space, and a broadcast system adopting a main band 1A′ is selected for broadcasting in the full region 1A.

A plurality of first regions 1B are defined in the full region 1A, and a broadcast system adopting a first secondary band 1B′ is selected in the first regions 1B. A plurality of second regions 1C are defined at centers of the first regions 1B in the full region 1A, and a broadcast system adopting a second secondary band 1C′ is selected in the second regions 1C. By alternately arranging the plurality of first regions 1B and the plurality of second regions 1C, the plurality of first regions 1B are spatially separated to prevent the respective broadcast systems from interfering one another. Further, the plurality of second regions 1C are spatially separated to prevent the respective broadcast systems from interfering one another.

At this point, although the first region 1B contains an overlapping part with the second region 1C, a third region 1D are may be further defined in the non-overlapping parts, and a broadcast system adopting a second band 1C′ is selected in the third region 1D. Given that the second regions 1C do not spatially overlap other third regions 1D, through a spatially staggering arrangement, the respective signals do not interfere one another. Thus, the third regions 1D may be in a plural number, and the band 1C′ may be used for broadcasting in the third regions 1D simultaneously. Similarly, although the second region 1C contains an overlapping part with the first regions 1B, a fourth region 1E may be further defined in the non-overlapping parts, and a broadcast system adopting a first secondary band 1B′ is selected in the fourth region 1E. Given that the first regions 1B do not overlap other fourth regions 1E, through a spatially staggering arrangement, the respective signals do not interfere one another. Thus, the fourth regions 1E may be in a plural number, and the first secondary band 1B′ may be used for broadcasting in the fourth regions 1E simultaneously.

### Second Embodiment

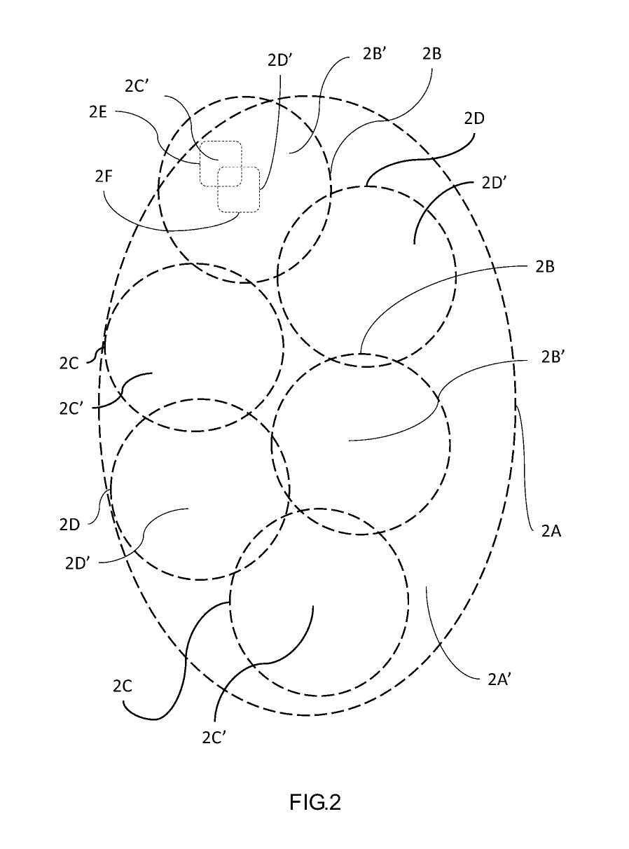

This embodiment is a cross-region multilevel band structure, as shown in FIG. 2. A full region 2A is defined in a space, and a broadcast system adopting a main band 2A′ is selected for broadcasting in the full region 2A.

A plurality of first regions 2B are defined in the full region 2A, and a broadcast system adopting a first secondary band 2B′ is selected in the first regions 2B. A plurality of second regions 2C are defined in the full region 2A, and a broadcast system adopting a second secondary band 2C′ is selected in the second regions 2C. A plurality of third regions 2D are then defined in the full region 2A, and a broadcast system adopting a third secondary band 2D′ is selected in the third regions 2D. By staggering and cyclically arranging the plurality of first regions 2B, the plurality of second regions 2C and the plurality of third regions, the plurality of first regions 2B are spatially separated from one another, the plurality of second regions 2C are spatially separated from one another, and the plurality of third regions 2D are spatially separated from one another, so as to prevent the broadcast systems using the same band therein from mutual interference.

At this point, although the first regions 2B contain overlapping parts with the second regions 2C or the third regions 2D, a fourth region 2E and a fifth region 2F may be further defined in the non-overlapping parts, a broadcast system adopting the second secondary band 2C′ is selected in the fourth region 2F, and a broadcast system adopting the third secondary band 2D′ is selected in the fifth region 2F. Thus, the fourth region 2E and the fifth region 2F may be applied simultaneously without interfering each other even if they spatially overlap.

### Third Embodiment

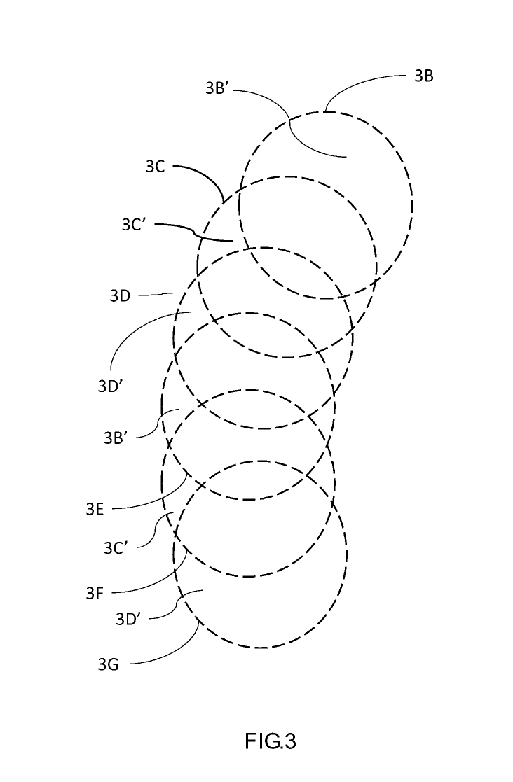

This embodiment is a cross-region multilevel band structure, as shown in FIG. 3. A first region 3B is first defined, and a broadcast system adopting a first secondary band 3B′ is selected in the first region 3B. A second region 3C is defined such that most of the second region 3C overlaps most of the first region 3B, and a broadcast system adopting a second secondary band 3C′ is selected in the second region 3C. A third region 3D is defined, such that most of the third region 3D overlaps most of the second region 3C and a remaining part of the third region 3D overlaps the first region 3B, and a broadcast system adopting a third secondary band 3D′ is selected in the third region 3D. The above approach is repeated to define a fourth region 3E, a fifth region 3F and a sixth region 3G, such that the fourth region 3E partially overlaps the second region 3C, the fifth region 3F partially overlaps the third region 3D, the sixth region 3G partially overlaps the fourth region 3E, and broadcast systems respectively adopting the first secondary band 3B′, the second secondary band 3C′ and the third secondary band 3D′ are respectively utilized in the fourth region 3E, the fifth region 3F and the sixth region 3G.

At this point, although both of the first region 3B and the fourth region 3E use the first secondary band 3B′, as shown in the drawing, mutual interference is not caused because they are spatially separated. Similarly, mutual interference is also prevented in the second region 3C and the fifth region 3F, and the third region 3D and the sixth region 3G by the spatial separation according to the above configuration.

### Fourth Embodiment

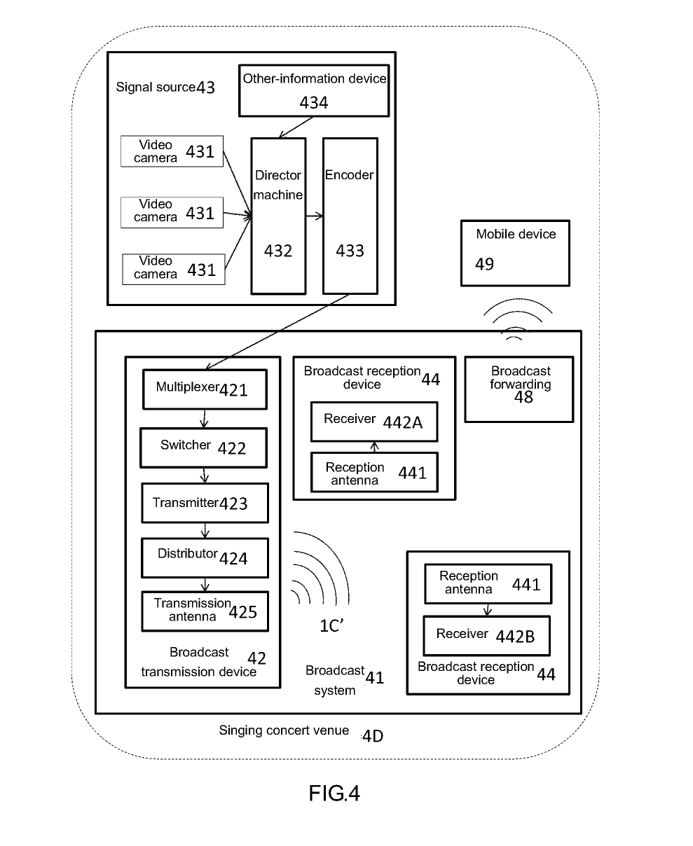

This embodiment is a cross-region multilevel band structure applied to image broadcast in a singing concert. FIG. 4 shows a schematic diagram of a cross-region multilevel band structure applied in a broadcast system for broadcasting images in a singing concert. A singing concert 4D is located in the third region 1D′ described in the first embodiment, and a broadcast system 41 adopts the second secondary band 1C′ to remain free from interference with the broadcast systems used in the full region 1A and the first regions 1B. The broadcast system 41 includes a broadcast transmission device 42 and a broadcast reception device 44. The broadcast transmission device 42 is formed by a multiplexer 421, a switcher 422, a transmitter 423, a distributor 424 and a transmission antenna 425. The broadcast reception device 44 is formed by a reception antenna 441 and a receiver 442. Because the broadcast system 41 allows multiple users to simultaneously receive broadcast signals, a part of the receivers may be implemented as receivers 442A with built-in tuners or receivers 442B externally connected to tuners. Further, in this embodiment, a signal source 43 providing signals to the broadcast system 41 is formed by multiple video cameras 431, a director machine 432, an encoder 433 and an other-information device 434.

The broadcast transmission device 42 and the signal source 43 are located in or near a singing convert venue 4D to readily capture and broadcast audiovisual information associated with the singing concert. The broadcast reception device 44 is located on or near bodies of the audiences of the singing concert 48 to readily obtain live broadcast of images of different angles at all times and at all places.

Further, a broadcast forwarding device 48 is further installed in the venue to transmit the broadcast signals received to mobile devices 49 handheld by users via wireless transmission such as WiFi and Bluetooth. Accordingly, viewers may view through the existing mobile devices 49 to facilitate viewing of a larger number of audiences. Further, the forwarding means achieved through the broadcast forwarding device 48 via wireless transmission such as WiFi and Bluetooth supplements a reception issue of signal dead area in the singing concert 4D, thereby facilitating viewing of a larger number of audiences.

In implementation, the multiple video cameras 431 are deployed at different positions in the singing concert venue 4D in advance to film images of different angles, and transmit information associated with the images to the director machine 432. At the director machine 432, the images respectively returned from the multiple video cameras 432 are integrated with video clips, sounds and special effects from the other-information device 434 and together transmitted to the encoder 433 for encoding. After the encoding, the images returned from the multiple video cameras 431 become multiples sets of information to be transmitted that is then transmitted to the broadcast transmission device 42.

When the multiple sets of information to be transmitted is transmitted to the broadcast transmission device 42, the multiple sets of information to be transmitted is first integrated through the multiplexer 421 and then transmitted to the switcher 422. While the switcher 422 stores the information to be transmitted to a stream storage device (not shown), the information to be transmitted is transmitted to the transmitter 423 to convert the information to be transmitted to electromagnetic signals for broadcast transmission. The electromagnetic signals are transmitted to the distributor 424, and the electromagnetic signals for broadcast transmission are transmitted to the space of the singing concert venue 4D through the antennas 425 deployed at different positions by using the second secondary band 1C′.

The audiences in the singing concert may receive the electromagnetic signals via the antennas 441 of the broadcast transmission devices 44, and restore the electromagnetic signals through the receivers 442 to watch the images that are integrated by the director machine 432 and returned from the multiple video cameras 431. Thus, the audiences are allowed to simultaneously enjoy images of different angles in the singing concert. Further, in the event of temporarily leaving the venue due to special conditions, contents of the singing concert may be uninterruptedly enjoyed during the way to achieve better enriched experiences of the singing concert.

### Fifth Embodiment

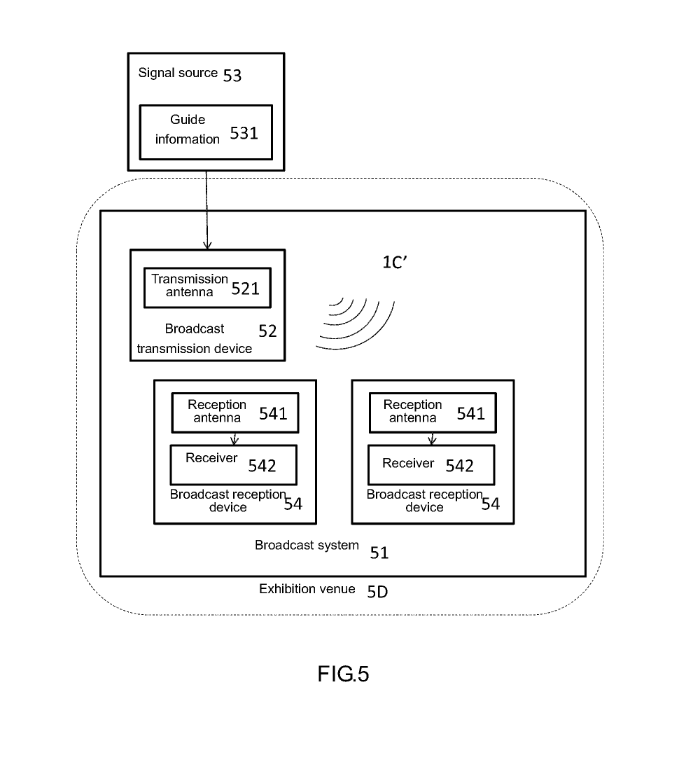

This embodiment is a cross-region multilevel band structure applied for broadcasting guide information in an exhibition venue. FIG. 5 shows a schematic diagram of a cross-region multilevel band structure applied in a broadcast system for broadcasting guide information in an exhibition venue. For example, an exhibition venue 5D is in the third region 1D described in the first embodiment, and a broadcast system 51 adopts the second secondary band 1C′ to remain free from interference with the broadcast system used in the full region 1A and the first regions 1B. The broadcast system 51 includes a broadcast transmission device 52 and a broadcast reception device 54. The broadcast transmission device 52 includes a transmission antenna 521. The broadcast reception device 54 is formed by a reception antenna 541 and a receiver 542. In this embodiment, a signal source 53 providing signals to the broadcast system 51 is formed by guide information 531.

In implementation, the guide information 531 serves as the signal source 53, and is transmitted to the broadcast transmission device 52 in the broadcast system 51. Further, electromagnetic signals including the guide information are transmitted to the exhibition venue 5D through the transmission antenna 521 in the broadcast transmission device 52 by using the second secondary band 1C′.

At this point, a tour guide device, handheld by a visitor and provided with the broadcast reception device 54, is capable of in real-time receiving the guide information, so as to allow the visitor to in real-time receive more diversified guide information to enrich user experiences.

In the second embodiment, although the broadcast system 51 is applied for tour guiding purposes in the exhibition venue 5D, the present invention is not limited thereto. More specifically, the broadcast system 51 may perform broadcasting by using the second secondary band 1C′, and may then be applied in an electronic gaming competition. Thus, through the broadcast reception device 54 installed in a virtual reality (VR) or augmented reality (AR), spectators are allowed to in real-time receive current electronic gaming competition situations transmitted by the broadcast transmission device 22. Further, in coordination with conventional wireless networks, spectators are enabled to bi-directionally select desired angles or images to allow the spectators to in real-time receive information of electronic gaming competition situations without difficulties caused by insufficient transmission speed. Further, the broadcast system may be applied to surgery teaching in the medical field or interactive teaching systems, so as to provide faster information broadcast for promoting teaching quality.

### Sixth Embodiment

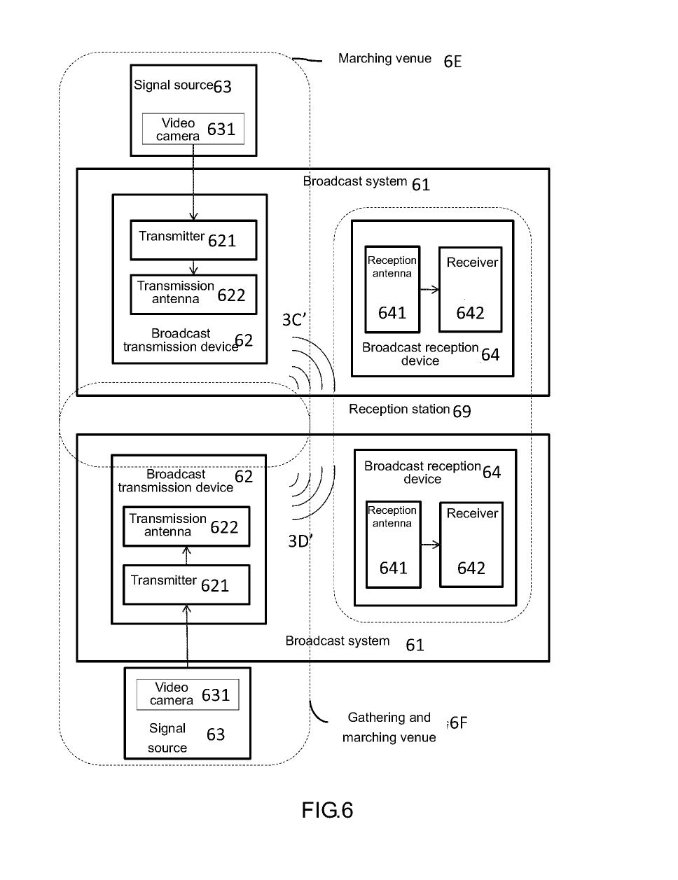

This embodiment is a cross-region multilevel band structure applied for broadcasting live scenes of a gathering and marching venue. FIG. 6 shows a cross-region multilevel band structure applied to a broadcast system for broadcasting live scenes at a gathering and marching venue. A gathering and marching venue 6E is located in the fourth region 2E described in the second embodiment, and a broadcast system 61 adopting the second secondary band 2C′ is selected; a gathering and marching venue 6F is located in the fifth region 2F described in the second embodiment, and a broadcast system 61 adopting the third secondary band 2D′ is selected. Even if the gathering and marching venues 6E and 6F cannot be geographically staggered, respective signals from these two venues do not mutually interfere because systems of different frequencies are utilized. Meanwhile, no interference with the broadcast systems used in the full region 2A and the first regions 2B is caused.

There are two sets of broadcast systems 61, which respectively adopt the second secondary band 2C′ and the third secondary band 2D′. The broadcast system 61 includes a broadcast transmission device 62 and a broadcast reception device 64. The broadcast transmission device 62 is formed by a transmitter 621 and a transmission antenna 622. The broadcast reception device 64 is formed by a reception antenna 641 and a receiver 642. In this embodiment, a signal source 63 providing signals to the broadcast system 61 is formed by a video camera 631.

The broadcast transmission devices 62 are located at the gathering and marching venues 6E and 6F and are connected to the signal source 63, such that the images captured by the video camera 631 may in real-time be transmitted through the broadcast transmission devices 62. The broadcast reception devices 64 are located at a reception station 69.

In implementation, the video camera 631 is connected with the transmitter 621, such that the images of the gathering and marching venues 6E and 6F that the video camera 631 captures are converted to electromagnetic signals via the transmitter 621 for broadcast transmission. The electromagnetic signals are then transmitted via the transmission antenna 622 by using the second secondary band 2C′ and the third secondary band 2D′.

The nearby broadcast reception device 64 deployed in the reception station 69 receives the electromagnetic signals of the second secondary band 2C′ and the third secondary band 2D′ via the reception antenna 641, and restores the electromagnetic signals to original image information. The reception station 69 is further disposed with a computer and an Internet device, through which the foregoing image information is transmitted to the Internet to achieve a live broadcast effect. By performing information broadcast using the above method, large amounts of satellite broadcast equipments are not required at the gathering and marching venues 6E and 6F, and so images of the scenes at the gathering and marching venues 6E and 6F may be captured with better mobility. Further, compared to 3G or 4G mobile communication networks, the above method prevents a predicament of not being able to transmit images due to network congestions of base stations.

### Seventh Embodiment

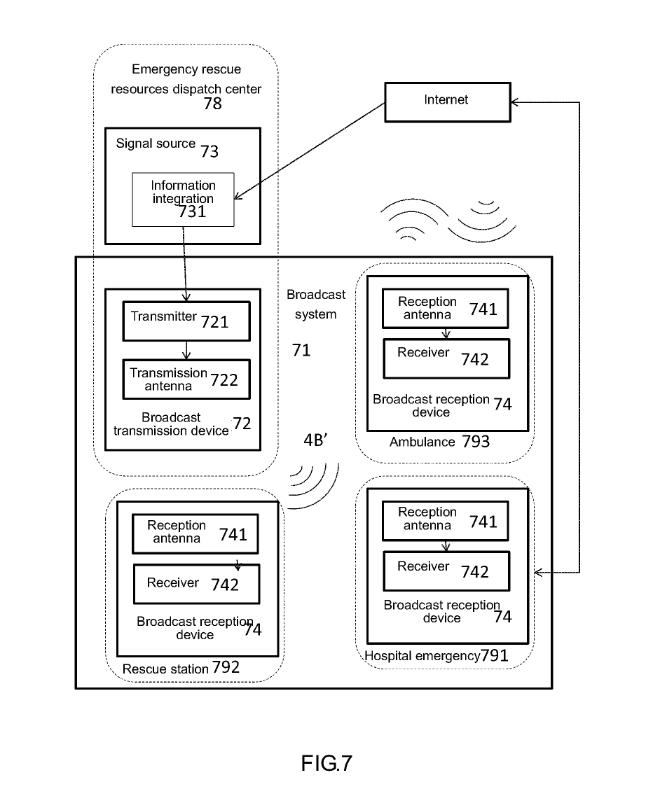

This embodiment is a cross-region multilevel band broadcast structure applied for broadcasting urgent messages associated with medical emergencies. FIG. 7 shows a schematic diagram of a cross-region multilevel band broadcast structure applied in a broadcast system for broadcasting urgent messages associated with medical emergencies. As shown, a broadcast region of messages associated with medical emergencies is located in the first region 2B described in the second embodiment, and the first region 2B is located in the full region 2A. A broadcast system 71 adopting the first secondary band 2B′ is selected in the first region 2B, and does not interfere the broadcast system (not shown) adopting the main band 2A′ in the full region 2A.

The broadcast system 71 includes a broadcast transmission device 72 and a broadcast reception device 74. The broadcast transmission device 72 is formed by a transmitter 721 and a transmission antenna 722. The broadcast reception device 74 is formed by a reception antenna 741 and a receiver 742. Further, a signal source 73 that provides signals to the broadcast system 71 is formed by an information integration platform 731.

The broadcast transmission device 72 and the signal source 73 are located at an emergency rescue resources dispatch center 78, and are connected to the information integration platform 731 serving as the signal source 73. The broadcast reception device 74 is in a plural quantity, and the plurality of broadcast reception device 74 are respectively located in a hospital emergency room 791, a rescue station 792 and an ambulance 793 at different locations in the region.

In implementation, in the hospital emergency room 791, the rescue station 792 and the ambulance 793, information associated with medical emergencies, such as bed vacancy information, current occupancy information, first aid material information and position information, is transmitted to the information integration platform 731 at the emergency and rescue resource dispatch center 78 through existing Internet systems or wireless communication systems. Through the information integration platform 731, integrated information of rescue resources at different locations are in real-time generated, converted to electromagnetic signals through the transmitter 721 in the broadcast transmission device 72, and transmitted via the antenna 722.

The hospital emergency room 791, the rescue station 792 and the ambulance 793 at different locations in the region receive the electromagnetic signals through the reception antennas 741 of the broadcast reception devices 74 installed therein, and in real-time restore the electromagnetic signals to integrated information of the rescue resources of different locations through the receivers 742. As such, the hospital emergency room 791, the rescue station 792 and the ambulance 793 at different locations can immediately learn conditions of one another to readily react at all times in response to sudden changes. Further, because transmission is performed by broadcast, unnecessary bandwidth waste caused by repeated point-to-point network transmission is prevented. Moreover, in events of emergencies, a predicament caused by network congestions of point-to-point transmission is eliminated to allow medical resources to be more appropriately distributed and exercised.

### Eighth Embodiment

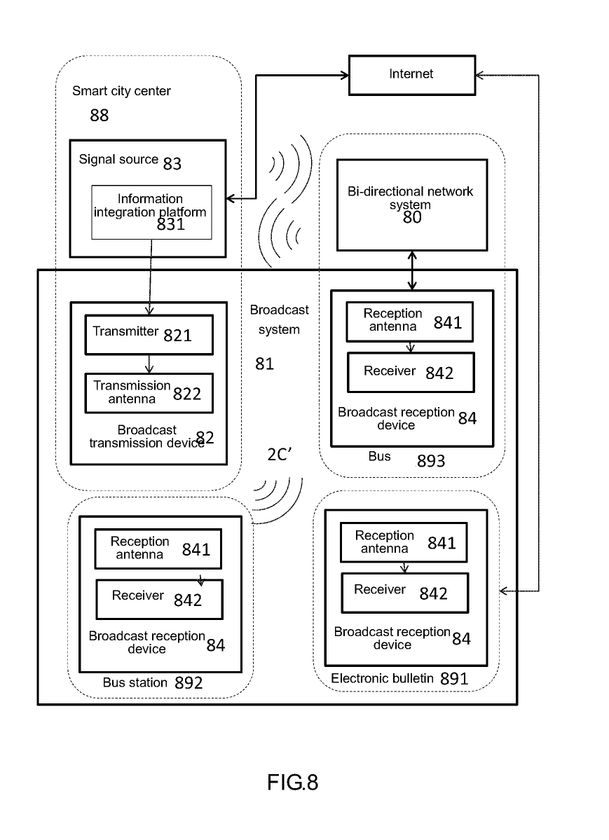

This embodiment is a cross-region multilevel band broadcast structure incorporating a bi-directional network applied for broadcasting integrated traffic information of a smart city. FIG. 8 shows a schematic diagram of a cross-region multilevel band broadcast structure applied in a broadcast system incorporating a bi-directional network for broadcasting integrated traffic information of a smart city. As shown, for example, the broadcast region of the integrated traffic information is located in the second region 2C described in the second embodiment, and the first region 2C is located in the full region 2A. A broadcast system 81 adopting the second secondary band 2C′ is selected in the first region 2C, and interference is not caused as a broadcast system (not shown) adopting the main band 2A′ is used in the full region 2A.

The broadcast system 81 includes a broadcast transmission device 82 and a broadcast reception device 84. The broadcast transmission device 82 is formed by a transmitter 821 and a transmission antenna 822. The broadcast reception device 84 is formed by a reception antenna 841 and a receiver 842. Further, a signal source 83 providing signals to the broadcast system 81 is formed by a smart city information platform 831.

The broadcast transmission device 82 and the signal source 83 are located at a smart city center 88, and is connected to the smart city information platform 831 serving as the signal source 83. The broadcast reception device 84 are in a plural quantity, and the plurality of broadcast reception devices 84 are respectively located at an electronic bulletin board 891, a bus station 892 and a bus 893 in the region.

In implementation, the buses 893 located at different positions may return respective location information and passenger information to the information integration platform 831 of the smart city center 88 through a bi-directional network 80, e.g., an existing 3G or 4G mobile network system or other wireless communication systems such as a low-bandwidth Low-Power Wide Area Network (LPWAN) or LoRa technologies. In the information integration platform 831, activity information of different locations is further integrated to generate real-time integrated traffic condition information, converted to electromagnetic signals through the transmitter 821 in the broadcast transmission device 82, and transmitted via the antenna 822.

The electronic bulletin board 891, the bus station 892 and the bus 893 at different locations in the region receive the electromagnetic signals via the reception antennas 841 of the broadcast reception devices 84 installed therein, and restore the electromagnetic signals to real-time integrated traffic condition information through the receivers 842. Thus, the awaiting public at the bus stations 892 at different locations may learn current progressing conditions of the buses. Further, the electronic bulletin board 891 may synchronously publish activity contents currently held and to be held as well as changes in traffic conditions to facilitate the public to plan everyday life schedules. The bus 893 allows bus passengers to learn current traffic conditions in real-time through receiving the real-time integrated traffic information at all times. Further, because transmission is performed by broadcast, unnecessary bandwidth waste caused by repeated point-to-point network transmission is prevented. Moreover, in events of emergencies, a predicament caused by network congestions of point-to-point transmission is eliminated. Further, by combining low-bandwidth and bi-directional LPWAN or LoRa technologies, in addition to reducing costs, a shortcoming of having inadequate data transmission size is supplemented, such that the integrated traffic information can be more appropriate utilized to alleviate partial regional traffic congestions.

Although this embodiment is applied for broadcasting of integrated traffic information of a smart city, the present invention is not limited thereto. The broadcast system 81 may also be applied to smart street light control, online map transmission, air quality information transmission and tourist information transmission to construct a convenient smart city. Further, multiple smart cities 2C may adopt 2C for broadcasting in the full region 2A. Thus, not only equipments can be shared to save costs, but also the various bands may be respectively effectively utilized in different regions to keep the band resources more active.

### Ninth Embodiment

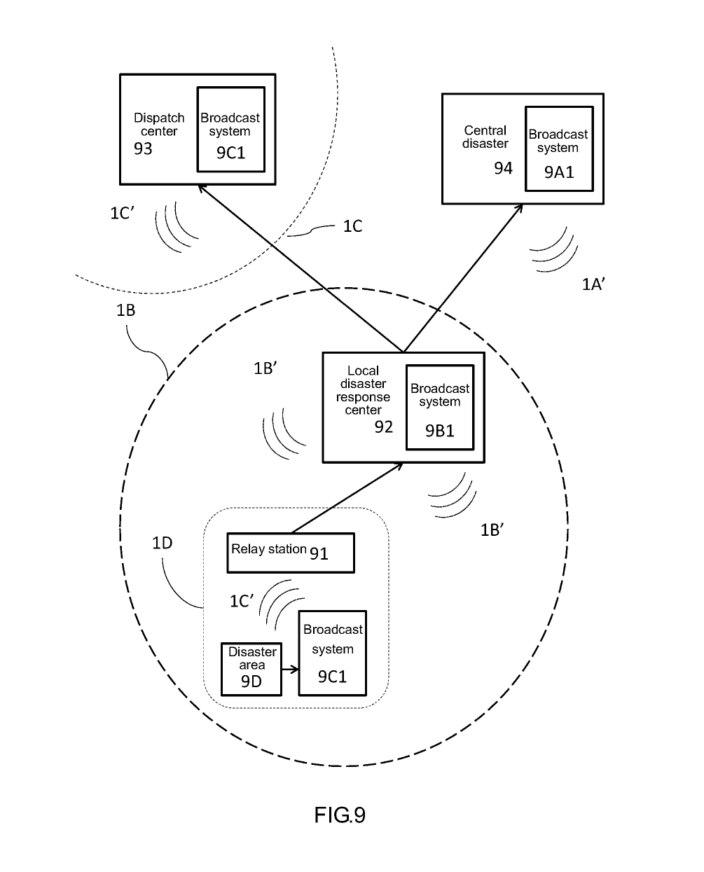

This embodiment is a cross-region multilevel band broadcast structure applied for broadcasting rescue information in the event of a major disaster. FIG. 9 shows a schematic diagram of cross-region multilevel band broadcast structure applied in a broadcast system for broadcasting rescue information in the event of a major disaster. As shown, for example, a search information broadcast region in the event of a major disaster is located in the full region 1A described in the first embodiment, and a disaster area 9D is located in the first region 1D. A broadcast system 9A1 adopting the main band 1A′ is utilized in the full region 1A, a broadcast system 9B1 adopting the first secondary band 1B′ is utilized in the first region 1B, and a broadcast system 9C1 adopting the second secondary band 1C′ is utilized in the second region 1C and the disaster area 9D.

In the event of a disaster, a local search and rescue team of the first region 1B is first dispatched to investigate the disaster, and utilizes the broadcast system 9C1 adopting the second secondary band 1C′ to transmit disaster images and location information of all major disaster zones in the disaster areas 9D through the configuration described above (in the second embodiment) to a relay station 91, which returns the disaster images and location information to a local disaster response center 92.

At this point, through the information returned from the broadcast system 9C1 via the relay station 91, the disaster response center 92 preliminarily estimates disaster conditions of different locations, and sends information associated with traffic control and emergency medical resource deployment to local rescue units, medical units, ambulances, police cars and road users in the first region 1B through the broadcast system 9B1 adopting the first secondary band 1B′ in the first region 1B according to the fifth embodiment, so as to notify the above recipients of traffic control information and guide the road users at different locations to successfully leave areas in which traffic is to be controlled. Meanwhile, the local disaster response center 92 may also send requirements associated with disaster rescue to a dispatch center 93 of the nearby second region 1C or a central disaster response center 94 in the full region 1A through existing networks. The dispatch center of the nearby second region 1C sends information of the requirements for disaster support by using the second secondary band 1C′ to the public in the second region 1C, so as to prompt the public in that area to quickly complete resource integration that can then be readily dispatched to the disaster regions.

The central disaster response center 94 may transmit the rescue process and search information to the public in the full region 1A using the broadcast system 9A1 adopting the main band 1A′. Thus, the public in the full region 1A are able to learn how to appropriately handle current situations and associated reactions to prevent chaos.

With the above method of a cross-region multilevel band broadcast structure, minimum band ranges can be effectively utilized to achieve region division and level division information broadcast, so as to further provide a full region emergency information dispatch and contact system for disaster areas to effectively improve current rescue efficiency. In addition to being applied to major disasters caused by earthquakes, the embodiment is also applicable to emergency information transmission for nuclear disasters or disasters caused by landslides to effectively broadcast information and to minimize damages of disasters.

### Tenth Embodiment

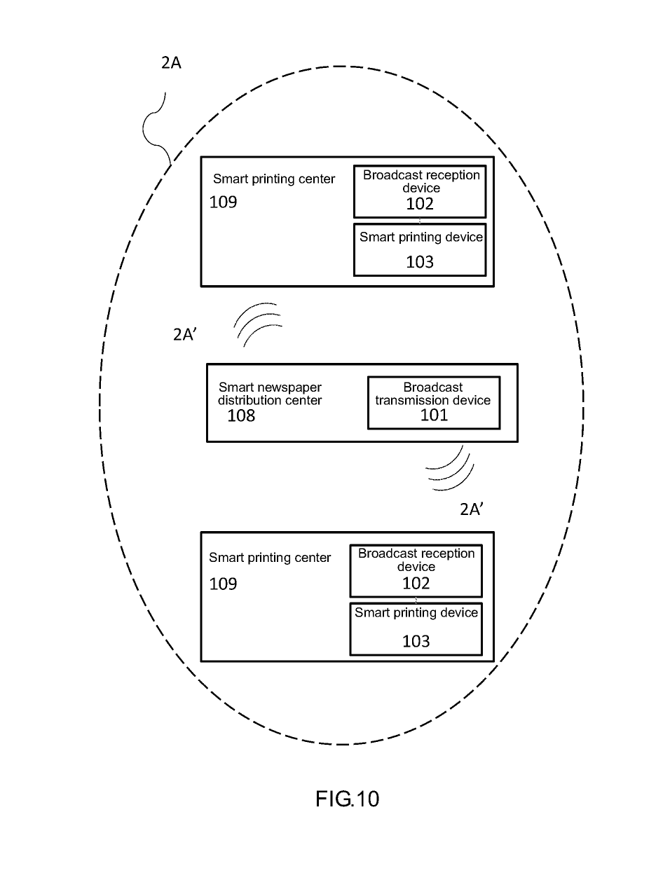

This embodiment is a cross-region multilevel band broadcast structure applied for broadcasting information of a smart newspaper distribution center. FIG. 10 shows a schematic diagram of a cross-region multilevel band broadcast structure applied in a broadcast system for broadcasting information of a smart newspaper distribution center. As shown, for example, a broadcast region of a smart newspaper distribution center 108 is located in the full region 2A described the second embodiment, and smart printing centers 109 are located in the full region 2A. A broadcast system adopting the main band 2A′ is utilized in the full region 2A. The broadcast system is formed by a broadcast transmission device 101 and a broadcast reception device 102. The broadcast transmission device 101 is located in the smart newspaper distribution center 108, and the broadcast reception device 102 is located in the smart printing center 109.

After editing of newspapers to be published on a current day is completed, the smart newspaper distribution center 108 may transmit such information through the broadcast transmission device 101 by using the main band 2A′. At this point, the smart printing centers 109 at different locations may receive the above information through the broadcast reception devices, and transmit the information to smart printing devices 103 for printing.

As such, through large-range broadcast using the broadcast system, complications of conventional newspaper distribution are eliminated to significantly enhance the efficiency of current newspaper distribution.

### Eleventh Embodiment

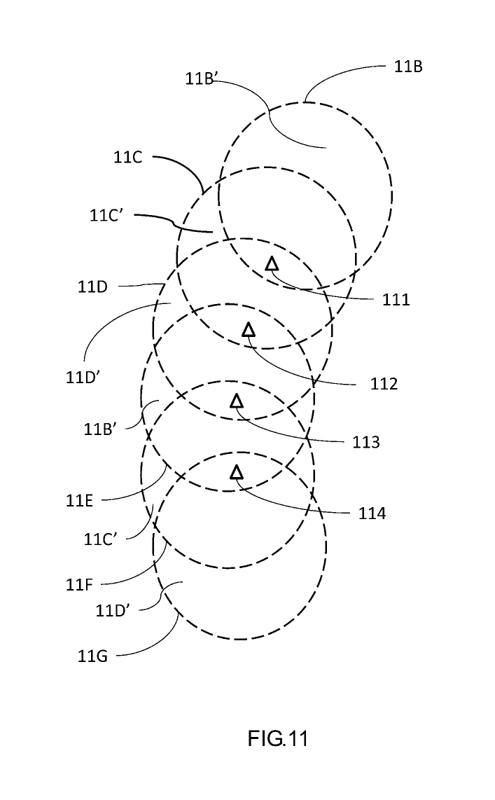

This embodiment is a cross-region multilevel band structure applied for assisting the broadcast of cross-region information by a backbone network. FIG. 11 shows a schematic diagram of a cross-region multilevel band structure applied to a broadcast system for broadcasting cross-region information of an auxiliary backbone network. As shown, in the cross-region multilevel broadcast structure similar to that in the third embodiment, a transmission station 111 is a signal center located in a second region 11C, and includes a receiver for receiving a first secondary band 11B′ and a third secondary band 11D′, and a transmitter for transmitting a second secondary band 11C′; a transmission station 112 is a signal center located in a third region 11D, and includes a receiver for receiving the first secondary band 11B′ and the second secondary band 11C′, and a transmitter for transmitting the third secondary band 11D; a transmission station 113 is a signal center located in a fourth region 11E, and includes a receiver for receiving the second secondary band 11C′ and the third secondary band 11D′, and a transmitter for transmitting the first secondary band 11B; and a transmission station 114 is a signal center located in a fifth region 11F, and includes a receiver for receiving the first secondary band 11B′ and the third secondary band 11D′, and a transmitter for transmitting the second secondary band 11C′.

The transmission station 111 is located at an overlapping part of the first region 11B and the third region 11D, such that the transmission station 111 is able to receive information transmitted by the first secondary band 11B′ in the first region 11B and information transmitted by the third secondary band 11D′ in the third region 11D. The transmission station 112 is located at an overlapping part of the second region 11C and the fourth region 11E, such that the transmission station 112 is able to receive information transmitted by the second secondary band 11C′ in the second region 11C and information transmitted by the first secondary band 113 in the fourth region 11D. The transmission station 113 is located at an overlapping part of the third region 11D and the fifth region 11F, such that the transmission station 113 is able to receive information transmitted by the third secondary band 11D′ in the third region 11D and information transmitted by the second secondary band 11C′ in the fifth region 11F. The transmission station 114 is located at an overlapping part of the fourth region 11E and the sixth region 11G, such that the transmission station 114 is able to receive information transmitted by the first secondary band 11B′ in the fourth region 11E and information transmitted by the third secondary band 11D′ in the sixth region 11G.

With the arrangement and configuration of the transmission stations 111, 112, 113 and 114, when the information transmitted by the first secondary band 11B′ in the first region 11B needs to be transmitted to the fifth region 11F and sent out, the information is first received by the receiver for receiving the first secondary band 11B′ in the transmission station 111 and then transmitted by the transmitter for transmitting the second secondary band 11C′ in the transmission station 111. At this point, the receiver for receiving the second secondary band 11C′ in the transmission station 112 receives the information transmitted from the transmitter for transmitting the second secondary band 11C′ in the transmission station 111, and meanwhile, the information is transmitted by the transmitter for transmitting the third secondary band 11D′ in the transmission station 112. As such, the information may be extended from the first region 11B into the range of the third region 11D.

Using the same method above, the transmission station 113 may receive the information transmitted by the third secondary band 11D′ from the transmission station 112, and the information may be broadcasted in the fourth region 11E using the first secondary band 11B′. The transmission station 114, by repeating the above method, receives the information transmitted by the first secondary band 11B′ from the transmission station 113, and broadcasts the information by the second secondary band 11B′ in the fifth region 11F. Thus, the information transmitted by the first secondary band 11B′ in the first region 11B is transmitted to the fifth region 11F and then broadcasted by the second secondary band 113 in the fifth region 11F, thereby achieving cross-region information broadcast and the function of assisting a backbone network. Although the transmission station 111 and the transmission station 114 use transmitters of the same band, the respective coverage regions are separated through arranging the transmission regions such that respective signals do not mutually interfere.

The invention has been described in terms of what is presently considered to be the most practical and preferred embodiments with the accompanying drawings. In the application, all disclosed features may be combined with other technical means, and each of the disclosed features may be selectively replaced by identical, equivalent or similar object feature. Thus, apart from particularly distinct features, the disclosed features in the application are some examples of equivalent or similar features. With the description of the preferred embodiments of the present invention, one person skilled in the art may understand that, the present invention is a novel and innovative invention offering practical industrial values. One person skilled in the art may make modifications (e.g., modifying fixed methods or fixed positions) without departing from the scope of the appended claims.

What is claimed is:

1. A method of a cross-region multilevel band broadcast structure, comprising:
selecting a main band, for broadcasting in a full region;
selecting a first secondary band, for broadcasting in first region within the full region; and
selecting a second secondary band, for broadcasting in a second region within the full region;
wherein, the main band, the first secondary band and the second secondary band are different bands.

2. The method of a cross-region multilevel band broadcast structure of claim 1, wherein the first region is in a plural quantity, and the plurality of first regions are not adjacent to one another in the full region.

3. The method of a cross-region multilevel band broadcast structure of claim 1, wherein the second region is in a plural quantity, and the plurality of second regions are not adjacent to one another in the full region.

4. The method of a cross-region multilevel band broadcast structure of claim 1, wherein both of the first region and the second region are in plural quantities, and are alternately arranged in the full region.

5. The method of a cross-region multilevel band broadcast structure of claim 1, further comprising:
selecting a third secondary band, for broadcasting in a third region within the full region.

6. The method of a cross-region multilevel band broadcast structure of claim 5, wherein the first region, the second region and the third region are in plural quantities and are staggered in an alternating arrangement, such that the plurality of first regions are not adjacent to one another, the plurality of second regions are not adjacent to one another and the plurality of third regions are not adjacent to one another.

7. A method for broadcasting under a cross-region multilevel band broadcast structure, comprising:
the method of a cross-region multilevel band broadcast structure of any of claim 1; and
selecting the second band for field broadcasting in a field within the first region;
wherein, the field is not adjacent to the second region.

8. A broadcast system, applied to a small field, comprising:
a broadcast transmission device, transmitting information from a signal source by means of broadcasting by using an idle band in the small field; and
a broadcast reception device, receiving the information transmitted through the band.

9. The broadcast system of claim 8, wherein the signal source is an audiovisual capturing device for capturing images as the information.

10. The broadcast system of claim 8, wherein the signal source is an information integration device that integrates a plurality of sets of multi-source data into the information.

11. The broadcast system of claim 10, wherein at least one set of the multi-source data is images of the small field captured by the audiovisual capturing device, and at least another set of the multi-source data is information inputted by an editor of the data.

12. The broadcast system of claim 8, wherein the small field is a singing concert venue, an exhibition venue or a sports venue.

13. The broadcast system of claim 8, wherein the band is a broadcast band or a digital television band.
